(19) United States
(12) Patent Application Publication
(10) Pub. No.: US 2008/0018810 A1
(43) Pub. Date: Jan. 24, 2008

(54) Picture Display Device

(76) Inventor: Toshihiro Moriiwa, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 11/628,111

(22) PCT Filed: Oct. 27, 2005
(86) PCT No.: PCT/JP05/19757

§ 371 Date: Dec. 1, 2006

(30) Foreign Application Priority Data
Nov. 25, 2004 (JP) 2004-340217

(51) Int. Cl. H04N 5/64

(52) U.S. Cl. 348/794; 348/E05.128

(57) ABSTRACT

A picture display device (1) comprises a power supply unit (3) operable to supply power from a power source (2), a picture size conversion unit (4) including a plurality of picture size conversion methods whose power consumption differs, a display unit (12) operable to display a picture for which size conversion is performed by one of the plurality of picture size conversion methods, a measurement unit (8) operable to measure remaining electric power amount of the power source, and a selection unit (9) operable to select one of the plurality of the picture size conversion methods according to the remaining electric power amount. The picture display device (1) appropriately suppresses electric power consumption; thereby, operating time of an electric device is extended.

### TECHNICAL FIELD

The present invention relates to a picture display device operable to change, according to remaining electric power amount, conversion methods which convert a picture size and to display the resized picture.

### BACKGROUND ART

A mobile phone or a portable terminal often comprises a picture display device operable to display a moving picture and a still picture. These portable terminals perform motion picture communications, for example, a videophone, using the picture display device. At this time, the picture size is suitably converted according to the specification of the portable terminal and user's needs.

Regarding such conversion of the picture size, Document 1 (Published Japanese patent application No. 2000-188689) discloses the art of a plurality of picture size conversion methods. Document 1 discloses a nearest neighbor method and a bilinear method as the plurality of picture size conversion methods. In these picture size conversion methods, the picture quality of the display picture after the size conversion differs depending on the methods.

In the picture size conversion, the pixels of a picture after the picture size conversion are obtained by interpolation using the pixels of a picture before the picture size conversion. FIG. 5 is a diagram showing interpolation of a pixel. A pixel P is a target pixel, that is a pixel after the picture size conversion. Pixels P1, P2, P3, and P4 are pixels which exist around the pixel P, before the picture size conversion.

In the nearest neighbor method, the pixel P is obtained by substituting a pixel that is the nearest to the pixel P. In FIG. 5, the pixel P4 is used.

On the other hand, in the bilinear method, assume that the horizontal and vertical positions of the pixel P are respectively given by the values a and b, which are equal to or greater than 0 and less than 1, then the pixel P is given by a value calculated by the expression: (1−a)×(1−b)×P1+a×(1−b)×P2+(1−a)×b×P3+a×b×P4.

There is a bicubic method besides the nearest neighbor method and the bilinear method. In the bicubic method, the pixel P is obtained by interpolation using eight neighboring pixels.

The plurality of picture size conversion methods differ in the respective operation amount and hence differ in respectively necessary power consumption amount. For example, the nearest neighbor method, which has the least operation amount, requires the lowest power consumption. The bicubic method, which has the largest operation amount, requires the highest power consumption. The bilinear method is in the middle between the nearest neighbor method and the bicubic method, regarding the power consumption.

Since these portable terminals are operated by batteries, control of electric power is important.

Document 2 (Published Japanese patent application No. 2003-280627) discloses the art of suppressing electric power consumption of a battery, by changing the modes of picture display according to reduction of remaining electric power amount of the battery. For example, when the remaining electric power amount has decreased, the number of tones of the display picture is reduced, or the frame rate is reduced. Alternatively, the luminance of a display light source is reduced. As a result, the power consumption is reduced, and the electric power consumption of the battery is suppressed.

However, in the picture display device of the conventional art, since the frame rate and the luminance are reduced depending on the remaining electric power amount, the balance of the degradation of picture quality and the suppression of electric power consumption is inadequate.

Since the change of picture size conversion methods is not performed in the conventional art, the picture size conversion method requiring the high power consumption is continuously used. Thus, the reduction of the frame rate and luminance is not enough to suppress the electric power consumption. This fact is of a problem. On the contrary, when the size conversion method with the low picture quality is selected, although the suppression of the electric power consumption is fully functioning, the picture display with the low picture quality continues. This fact is of another problem.

### DISCLOSURE OF THE INVENTION

An object of the present invention is to provide a picture display device operable to change picture size conversion methods, depending on the remaining electric power amount, and suppress the electric power consumption with keeping the most suitable balance between the picture quality and the power consumption.

A first aspect of the present invention provides a picture display device comprising: a power supply unit operable to supply electric power from a power source; a picture size conversion unit possessing a plurality of picture size conversion methods with mutually different power consumption; a display unit operable to display a picture converted in size in accordance with one of the plurality of picture size conversion methods; a measurement unit operable to measure remaining electric power amount of the power source; and a selecting unit operable to select one of the plurality of picture size conversion methods depending on the remaining electric power amount.

According to the structure, a picture size conversion method having different power consumption is selected depending on the remaining electric power amount. Thereby, it is possible to maintain the balance between the power consumption and the picture quality.

A second aspect of the present invention provides the picture display device, wherein in cases where the power source includes a battery, the measurement unit is operable to measure remaining electric power amount of the battery.

According to the structure, even when a power-consuming battery is used, it is possible to continue the picture size conversion, while suppressing the electric power consumption.

A third aspect of the present invention provides the picture display device, wherein the selecting unit is operable to select a picture size conversion method which operates with lower power consumption among the plurality of picture size conversion methods, depending on decrease in the remaining electric power amount measured by the measurement unit.

According to the structure, when the remaining electric power amount is not sufficient, the picture size conversion method having low power consumption is used. Thus, the electric power consumption is suppressed.

A fourth aspect of the present invention provides the picture display device, wherein in cases where the power source includes a battery and a commercial power source and where the power supply unit supplies electric power from the battery, the selecting unit is operable to select, among the plurality of picture size conversion methods, a picture size conversion method which operates with lower power consumption than a picture size conversion method selected in cases where the power supply unit supplies the electric power from the commercial power source.

According to the structure, even in a case where the battery and the commercial power source are interchangeably used, the processing of the picture size conversion is performed, taking into consideration of the remaining electric power amount.

A fifth aspect of the present invention provides the picture display device, wherein the plurality of picture size conversion methods includes at least one of a nearest neighbor method, a bilinear method, and a bicubic method.

According to the structure, the picture display device can include a plurality of picture size conversion methods having different power consumption. By properly selecting a picture size conversion method from the plurality of the picture size conversion methods, the electric power consumption is suppressed.

A sixth aspect of the present invention provides the picture display device, wherein the selecting unit is operable to select the bicubic method when the remaining electric power amount is equal to or greater than a first threshold value, wherein the selecting unit is operable to select the bilinear method when the remaining electric power amount is equal to or greater than a second threshold value but less than the first threshold value, and wherein the selecting unit is operable to select the nearest neighbor method when the remaining electric power amount is less than the second threshold value.

According to the structure, a picture size conversion method having low power consumption is selected depending on the reduction in the remaining electric power amount.

A seventh aspect of the present invention provides the picture display device further comprising: a clock supply unit operable to supply a clock signal to the picture display device, wherein the clock supply unit is operable to change a frequency of the clock signal when the selecting unit changes the picture size conversion method.

According to the structure, since the power consumption is reduced further in addition to the power consumption reduction accomplished by the change of the picture size conversion methods, the electric power consumption is suppressed effectively.

An eighth aspect of the present invention provides the picture display device, wherein each of the plurality of picture size conversion methods is set up to operate at a different frequency of the clock signal, and wherein the clock supply unit is operable to supply the clock signal with a frequency corresponding to the selected picture size conversion method, in accordance with the change of the picture size conversion method in the selecting unit.

According to the structure, the electric power consumption is suppressed effectively.

A ninth aspect of the present invention provides the picture display device, wherein each of the plurality of picture size conversion methods uses a specific memory among a plurality of memories possessing different memory sizes, and wherein when the selecting unit selects one of the plurality of picture size conversion methods, the power supply unit is operable to cut off the electric power to be supplied to the plurality of memories except the memory used by the picture size conversion method selected.

According to the structure, the electric power consumption is suppressed further effectively.

According to the picture display device of the present invention, the picture size conversion method can be changed according to the remaining electric power amount, and the electric power consumption can be suppressed appropriately. In a case where the remaining electric power amount is sufficient, a picture size conversion method with high picture quality is selected, and a picture with high picture quality is displayed. On the other hand, in a case where the remaining electric power amount is inadequate, a picture size conversion method with low power consumption is selected, while sacrificing the picture quality. In this way, balance of the picture quality and the power consumption is realized.

Further suppression of the electric power consumption can be realized, in accordance with selection of the picture size conversion methods, by restricting the supply of the electric power to an unnecessary memory and changing the frequency of the clock signal.

### BRIEF DESCRIPTION OF THE DRAWINGS

FIG. 1 is a block diagram illustrating a picture display device in Embodiment 1 of the present invention;

FIG. 2 is a block diagram illustrating a picture display device in Embodiment 2 of the present invention;

FIG. 3 is a block diagram illustrating a picture display device in Embodiment 3 of the present invention;

FIG. 4 is a block diagram illustrating a picture display device in Embodiment 4 of the present invention; and

FIG. 5 is a diagram showing interpolation of a pixel.

### BEST MODE FOR CARRYING OUT THE INVENTION

Embodiments of the present invention is explained in the following, referring to the accompanying drawings.

### Embodiment 1

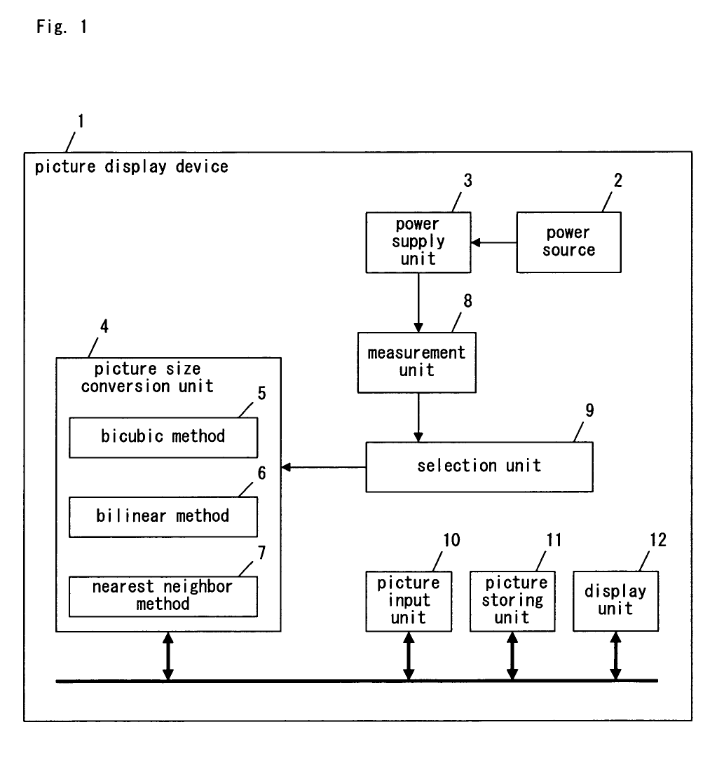

FIG. 1 is a block diagram illustrating a picture display device in Embodiment 1 of the present invention.

A picture display device 1 comprises the following elements.

A power source 2 supplies the electric power to each element included in the picture display device 1 via a power supply unit 3. A picture size conversion unit 4 converts the picture size of an input picture using a plurality of picture size conversion methods which possess different power consumption. In FIG. 1, the picture size conversion unit 4 possesses three picture size conversion methods; a bicubic method 5, a bilinear method 6, and a nearest neighbor method 7. A display unit 12 displays the resized picture. A measurement unit 8 measures the remaining electric power amount of the power source 2. A selection unit 9 selects one of a plurality of picture size conversion methods which are included in the picture size conversion unit 4, according to the remaining electric power amount.

The details and operation of each unit are explained.

First, the picture size conversion unit 4 is explained. The picture size conversion unit 4 reduces or enlarges the picture size of an input picture. Here, the picture size conversion unit 4 possesses a plurality of picture size conversion methods with different power consumption.

The bicubic method 5 generates a converted pixel by interpolation, using all neighboring pixels around the converted pixel. The bicubic method 5, implemented in hardware or software, requires a large amount of power consumption, since a lot of calculations such as multiplication and addition are necessary in the interpolation. However, since many neighboring pixels are used in the interpolation, the picture quality of the picture after the size conversion is high.

Next, the bilinear method 6 generates a converted pixel by interpolation, using four neighboring pixels around the converted pixel. In the interpolation, multiplication and addition are performed by using the four pixels' values and coefficients. For this reason, the bilinear method 6, installed in hardware or software, requires a large amount of operation and a large amount of power consumption. However, since the operation amount of the bilinear method 6 is smaller than that of the bicubic method 5, the power consumption of the bilinear method 6 is lower than that of the bicubic method 5. The quality of picture resized by the bilinear method 6 is lower than the quality of picture resized by the bicubic method 5, but higher than the quality of picture resized by the nearest neighbor method 7 described below.

The nearest neighbor method 7 generates a converted pixel using a pixel nearest to the converted pixel. Since the nearest neighbor method 7 uses only one pixel in the generation, the operation amount is small. For this reason, the nearest neighbor method 7 has the lowest power consumption among the three picture size conversion methods. However, the resized picture by the nearest neighbor method 7 exhibits conspicuous jaggies. Thus, the picture quality after the conversion is poorer than those of the other picture size conversion methods.

The picture size conversion unit 4 possesses a plurality of picture size conversion methods with the different power consumption due to the different calculation processing as described above.

Here, the three methods, that is, the bicubic method 5, the bilinear method 6, and the nearest neighbor method 7, have been described as the example, however, the other methods may be included.

The following explains the measurement unit 8.

The measurement unit 8 measures the remaining electric power amount of the power source 2. The measurement unit 8 measures the remaining electric power amount by measuring the current from the power source 2, for example. At this time, the measurement unit 8 may measure the remaining electric power amount as an absolute numeric value, or as the remaining amount level on the basis of a threshold which is set arbitrarily.

When the power source 2 includes a battery, the measurement unit 8 measures the remaining electric power amount of the battery. Thus, the selection unit 9 operates according to the remaining electric power amount of the battery.

The following explains the selection unit 9.

The selection unit 9 selects one of the plurality of picture size conversion methods included in the picture size conversion unit 4, according to the remaining electric power amount that is measured by the measurement unit 8. The selection unit 9 defines a certain value of voltage, current or electric power, as a threshold. The selection unit 9 selects a picture size conversion method based on the threshold.

For example, the selection unit 9 sets up a first threshold and a second threshold for electric power. Here, the remaining electric power amount of the first threshold is larger than that of the second threshold. The selection unit 9 compares the remaining electric power amount notified by the measurement unit 8, with the first threshold and the second threshold. As a result of the comparison, it is judged whether the remaining electric power amount is larger than the first threshold, larger than the second threshold but smaller than the first threshold, or smaller than the second threshold.

Alternatively, the measurement unit 8 may possess the first threshold and the second threshold and the measurement unit 8 may judge whether the measured remaining electric power amount is larger than the first threshold, larger than the second threshold and smaller than the first threshold, or smaller than the second threshold. Then, the measurement unit 8 may output the result to the selection unit 9.

When the remaining electric power amount is larger than the first threshold, the selection unit 9 selects the bicubic method 5. This is because the remaining electric power amount is enough, and because the bicubic method 5 having the best picture quality after conversion is the most suitable as a selection candidate. When the remaining electric power amount is larger than the second threshold and smaller than the first threshold, the selection unit 9 selects the bilinear method 6. The bilinear method 6, which possesses the middle level of the power consumption and the picture quality, is selected because it is the most suitable as the selection candidate. When the remaining electric power amount is smaller than the second threshold, the selection unit 9 selects the nearest neighbor method 7. This is because the remaining electric power amount is the least, and because the nearest neighbor method having the least power consumption is the most suitable as a selection candidate.

The procedure of these selections is an example. Setup of the threshold and the relation between the threshold and the picture size conversion method to be selected may be arbitrarily defined. The setup may be changed ex post.

When a battery is used as the power source 2, the measurement unit 8 measures the remaining electric power amount of the battery and the selection unit 9 selects the picture size conversion method according to the remaining electric power amount of the battery.

If the picture size conversion unit 4 includes further more picture size conversion methods, the selection unit 9 sets up further more thresholds, and selects a picture size conversion method.

The selection result in the selection unit 9 is notified to the picture size conversion unit 4. After receiving the notification, the picture size conversion unit 4 actually performs conversion of the picture size according to the selected picture size conversion method. The resized picture data is stored in a picture storing unit 11. A display unit 12 reads and displays the resized picture data that is stored. The display unit 12 comprises a liquid crystal display, for example.

The resized picture is finally displayed on the display unit 12, converted with the picture size conversion method that is selected according to the remaining electric power amount in the selection unit 9. Since the picture size conversion method is selected with consideration given to the remaining electric power amount, it is possible to suppress the consumption of the power source.

### Embodiment 2

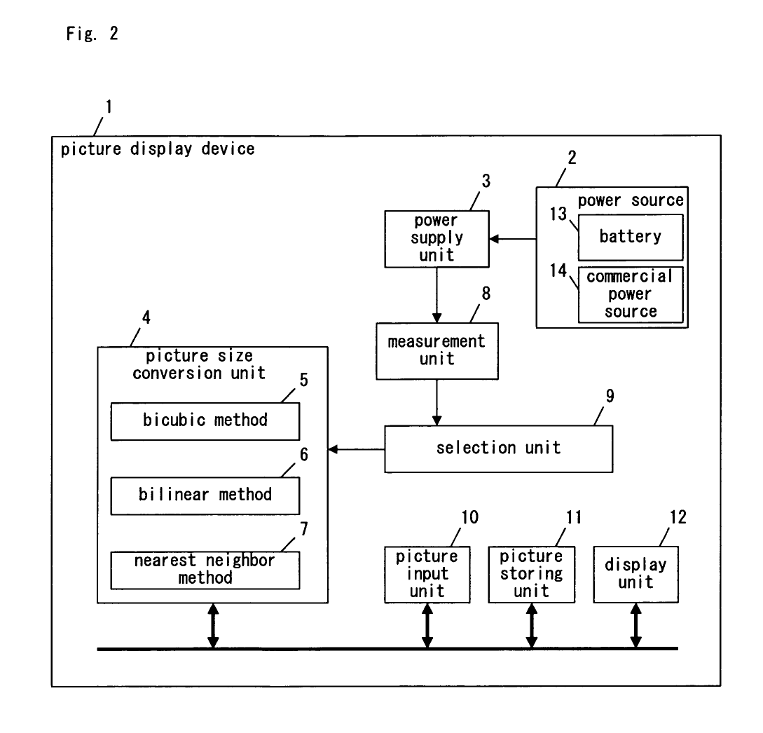

The following explains Embodiment 2 referring to FIG. 2.

FIG. 2 is a block diagram illustrating a picture display device in Embodiment 2 of the present invention. Dissimilar to FIG. 1, a power source 2 comprises a battery 13 and a commercial power source 14. The picture display device 1 is supplied electric power from the commercial power source 14 or the battery 13, depending on the switchover by a user. For example, when the commercial power source 14 cannot supply the electric power, the battery 13 supplies the electric power.

When the battery 13 supplies the electric power in the power source 2, a measurement unit 8 measures remaining electric power amount. The measurement result is notified to a selection unit 9. The selection unit 9 selects a picture size conversion method according to the remaining electric power amount. The selection is the same as what is explained in Embodiment 1.

In Embodiment 2, a picture size conversion method is selected according to a case where the commercial power source 14 is used as the power source 2 or a case where the battery 13 is used.

For example, when the commercial power source 14 is used as the power source 2, the bicubic method 5 and the bilinear method 6 having the high power consumption are selected. When the commercial power source 14 is used, it is rare for the remaining electric power amount to decline. Thus, it is suitable to select the bicubic method 5 and the bilinear method 6 having the high picture quality even though the power consumption is high.

With the method selected by the selection unit 9, a picture size conversion unit 4 performs the size conversion for an input picture, and stores the resized picture data in a picture storing unit 11. A display unit 12 takes out the resized picture data from the picture storing unit 11, and displays the resized picture.

On the other hand, when the battery 13 is used as the power source 2, the nearest neighbor method 7 having low power consumption is selected. When the battery 13 is used, it is necessary to suppress the electric power consumption at a maximum level. Thus, a picture size conversion method having low power consumption is selected. By this means, it is possible to minimize the power consumption while the battery 13 is used, by selecting the picture size conversion method having low power consumption from the beginning.

Of course, as explained in Embodiment 1, even in a case where the battery 13 is used, the picture size conversion method may be changed according to the remaining electric power amount.

The selection unit 9 judges which one of the battery 13 and the commercial power source 14 is used, based on the notification from, for example, a power source changeover switch arranged in an electronic device in which the picture display device 1 is installed. In other words, the picture size conversion method is selected in conjunction with setup-operation of a user (for example, the setup-operation of the power source changeover switch).

When the commercial power source 14 supplies the electric power and the power consumption is not an issue by the above-mentioned processing, the priority is given to the picture quality of a picture to be displayed. When the battery 13 supplies the electric power and the power consumption is the issue, the priority is given to the power consumption instead of the picture quality. As a result, it is possible to suitably realize the balance between the operating time and the displayed-picture quality of the electronic device.

### Embodiment 3

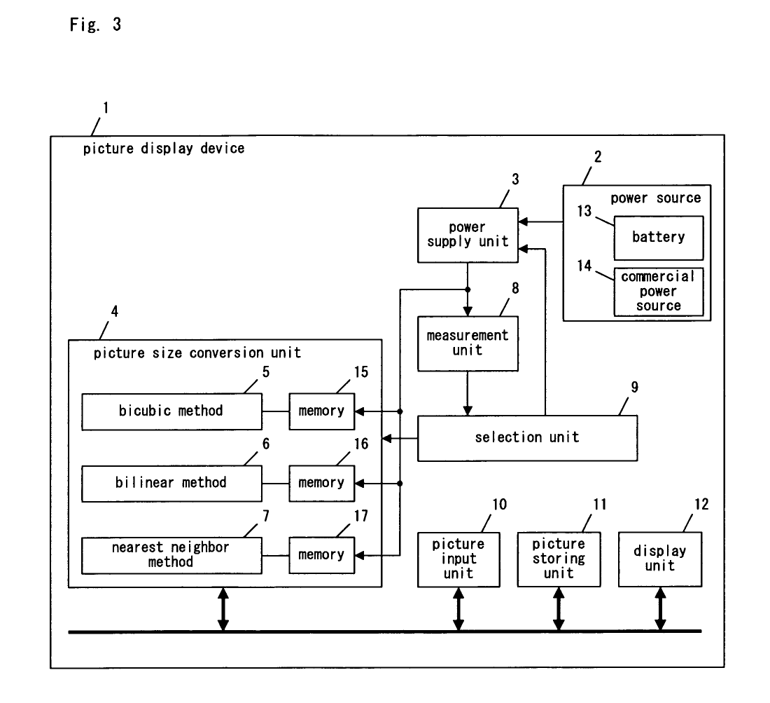

The following explains Embodiment 3 referring to FIG. 3.

FIG. 3 is a block diagram illustrating a picture display device in Embodiment 3 of the present invention. In the picture display device 1 of Embodiment 3, by limitation of electric supply to memories included in a picture size conversion unit 4, it is possible to further suppress power consumption of a power source 2.

A memory 15, a memory 16, and a memory 17 are installed in the picture size conversion unit 4.

The memory 15 stores an intermediate result, for example, of operation when interpolation is performed with the bicubic method 5. In other words, the memory 15 is used as an exclusive memory of the bicubic method 5.

The memory 16 stores an intermediate result, for example, of operation when interpolation is performed with the bilinear method 6. In other words, the memory 16 is used as an exclusive memory of the bilinear method 6.

The memory 17 stores, for example, an intermediate result of operation when pixel generation is performed with the nearest neighbor method 7. In other words, the memory 17 is used as an exclusive memory of the nearest neighbor method 7.

In FIG. 3, the memories 15 to 17 are included inside of the picture size conversion unit 4. However, the memories may be installed separately in an actual device.

The power supply unit 3 receives the selection result of the selection unit 9, and then cuts off the supply of electric power to the memory which the unchosen picture size conversion method uses. For example, when the selection unit 9 selects the bicubic method 5, the power supply unit 3 cuts off the supply of electric power to the unused memory 16 and memory 17. When the selection unit 9 selects the bilinear method 6, the power supply unit 3 cuts off the supply of electric power to the unused memory 15 and memory 17. When the selection unit 9 selects the nearest neighbor method 7, the power supply unit 3 cuts off the supply of electric power to the unused memory 15 and memory 16.

It is also suitable to cut off the supply of electric power to a circuit, which practices the unchosen picture size conversion method, as well as the memory. It is possible to further suppress the electric power consumption by limiting the supply of electric power to a circuit constituting a calculating unit which is used for the picture size conversion, for example.

As mentioned above, the electric power consumption can be further suppressed by limiting the supply of electric power based on the selection result in the selection unit 9.

### Embodiment 4

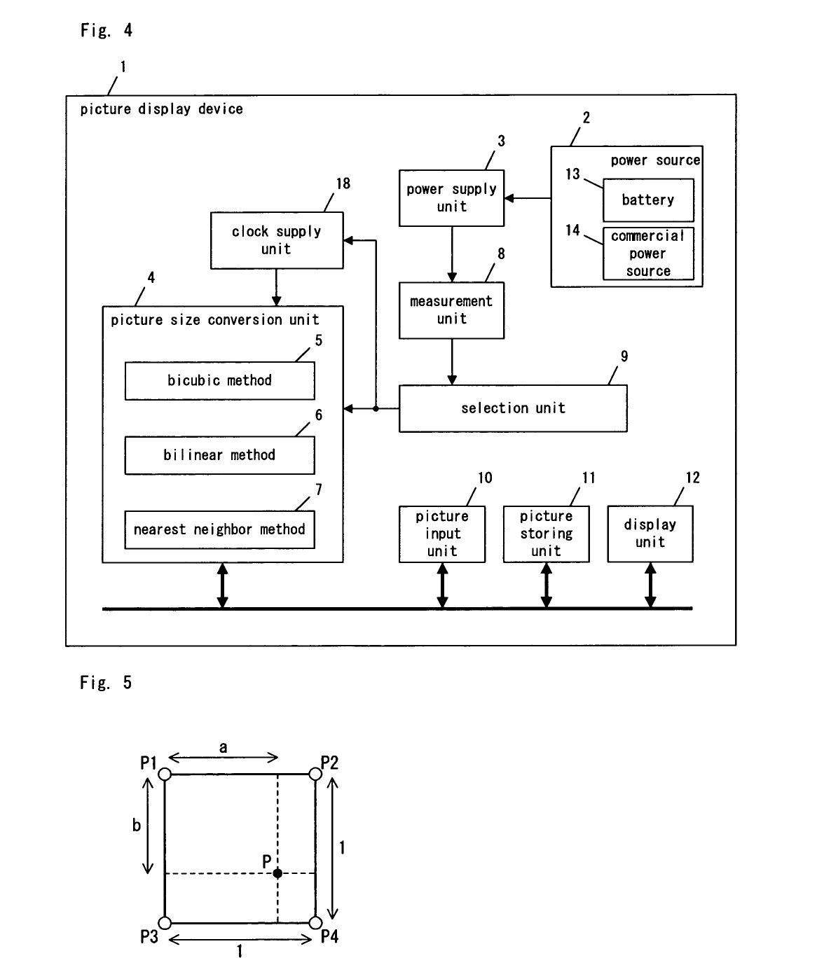

The following explains Embodiment 4 referring to FIG. 4.

FIG. 4 is a block diagram illustrating a picture display device in Embodiment 4 of the present invention. Dissimilar to FIG. 1, a clock supply unit 18 is arranged in FIG. 4. The memories 15 to 17 shown in FIG. 3 are also arranged if necessary.

The clock supply unit 18 supplies a clock signal to the inside of the picture display device 1. In particular, the clock signal is supplied to a picture size conversion unit 4.

The clock supply unit 18 receives a notification of the selection result of a selection unit 9. By the notification, the clock supply unit 18 can recognize which picture size conversion method is chosen among the plurality of picture size conversion methods. The clock supply unit 18 increases or decreases the frequency of the clock signal to be outputted based on the recognition. For example, when the nearest neighbor method 7 is selected, since the remaining electric power amount is not sufficient, the clock supply unit 18 decreases the frequency of the clock signal to be outputted.

The electric power consumption is further suppressed by the frequency decrease of the clock signal. On the contrary, when the bicubic method 5 and the bilinear method 6 are selected, the clock supply unit 18 maintains the frequency of the clock signal to be outputted in the regular frequency.

By the above-mentioned processing, when the remaining electric power amount is sufficient, the clock signal is supplied at a frequency at which the picture size conversion can be performed at high speed. When the remaining electric power amount is decreased, a picture size conversion method having low power consumption is selected, and in addition, the clock frequency is decreased. Thus, the electric power consumption is further suppressed. As explained in Embodiment 3, it is also preferred that the supply of electric power to a memory, a circuit, and so on, which practice the unchosen picture size conversion method, is simultaneously restricted. Then it is possible to further suppress the electric power consumption.

The clock supply unit 18 may output a clock signal at different frequencies for every picture size conversion method.

For example, the clock supply unit 18 outputs a clock signal having the frequency of 30 MHz in a case of the bicubic method 5, a clock signal having the frequency of 25 MHz in a case of the bilinear method 6, and a clock signal having the frequency of 20 MHz in a case of the nearest neighbor method 7.

The clock supply unit 18 outputs a clock signal having the frequency corresponding to the selected picture size conversion method according to the selection result in the selection unit 9. Following the above-mentioned example, when the selection unit 9 selects the bicubic method 5, the clock supply unit 18 outputs the clock signal having the frequency of 30 MHz. When the selection unit 9 selects the bilinear method 6, the clock supply unit 18 outputs the clock signal having the frequency of 25 MHz. When the selection unit 9 selects the nearest neighbor method 7, the clock supply unit 18 outputs the clock signal having the frequency of 20 MHz. When a picture size conversion method having the low power consumption due to the difference of the operation amount is selected, the clock frequency is also decreased; therefore, further suppression of the electric power consumption is performed.

As mentioned above, it is also preferable for the clock supply unit 18 to switch the clock frequency corresponding to the selected picture size conversion method, instead of for the clock supply unit 18 to increase or decrease the clock frequency.

It is possible to suitably decrease the power consumption by the picture display device 1 described in Embodiment 4, depending on the remaining electric power amount.

### INDUSTRIAL APPLICABILITY

The present invention can be suitably used in an electronic device, such as a portable terminal comprising a picture display device operable to suppress electric power consumption appropriately.

1. A picture display device comprising:
a power supply unit operable to supply electric power from a power source;
a picture size conversion unit possessing a plurality of picture size conversion methods with mutually different power consumption;
a display unit operable to display a picture converted in size in accordance with one of the plurality of picture size conversion methods;
a measurement unit operable to measure remaining electric power amount of the power source; and
a selecting unit operable to select one of the plurality of picture size conversion methods depending on the remaining electric power amount.

2. The picture display device as defined in claim 1, wherein in cases where the power source includes a battery, said measurement unit is operable to measure remaining electric power amount of the battery.

3. The picture display device as defined in claim 1, wherein said selecting unit is operable to select a picture size conversion method which operates with lower power consumption among the plurality of picture size conversion methods, depending on decrease in the remaining electric power amount measured by said measurement unit.

4. The picture display device as defined in claim 1, wherein in cases where the power source includes a battery and a commercial power source and where said power supply unit supplies electric power from the battery, said selecting unit is operable to select, among the plurality of picture size conversion methods, a picture size conversion method which operates with lower power consumption than a picture size conversion method selected in cases where said power supply unit supplies the electric power from the commercial power source.

5. The picture display device as defined in claim 1, wherein the plurality of picture size conversion methods includes at least one of a nearest neighbor method, a bilinear method, and a bicubic method.

6. The picture display device as defined in claim 1, wherein said selecting unit is operable to select the bicubic method when the remaining electric power amount is equal to or greater than a first threshold value,
wherein said selecting unit is operable to select the bilinear method when the remaining electric power amount is equal to or greater than a second threshold value but less than the first threshold value, and
wherein said selecting unit is operable to select the nearest neighbor method when the remaining electric power amount is less than the second threshold value.

7. The picture display device as defined in claim 1, further comprising: a clock supply unit operable to supply a clock signal to said picture display device,
wherein said clock supply unit is operable to change a frequency of the clock signal when said selecting unit changes the picture size conversion method.

8. The picture display device as defined in claim 1, wherein each of the plurality of picture size conversion methods is set up to operate at a different frequency of the clock signal, and
wherein said clock supply unit is operable to supply the clock signal with a frequency corresponding to the selected picture size conversion method, in accordance with the change of the picture size conversion method in said selecting unit.

9. The picture display device as defined in claim 1, wherein each of the plurality of picture size conversion methods uses a specific memory among a plurality of memories possessing different memory sizes, and
wherein when said selecting unit selects one of the plurality of picture size conversion methods, said power supply unit is operable to cut off the electric power to be supplied to the plurality of memories except the memory used by the picture size conversion method selected.
